(19) United States
(12) Patent Application Publication
(10) Pub. No.: US 2023/0383485 A1
(43) Pub. Date: Nov. 30, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Aichi-ken (JP)

(72) Inventors: Toyokazu NAKASHIMA, Nagoya-shi (JP); Takeshi TAKEMOTO, Nagoya-shi (JP)

(21) Appl. No.: 18/181,571

(22) Filed: Mar. 10, 2023

(30) Foreign Application Priority Data
May 24, 2022 (JP) 2022-084713

(51) Int. Cl. E01C 23/01

(52) U.S. Cl. CPC E01C 23/01

(57) ABSTRACT

In an information processing device according to the present disclosure, a control unit collects vehicle information including a wheel speed change rate acquired by a vehicle traveling on each of a plurality of road sections. The control unit executes a first process of estimating a road surface state of each road section based on the collected vehicle information. At this time, the control unit executes the first process by excluding, from among the road sections, a first road section where first construction related to repair of a road surface has been performed.

### CROSS-REFERENCE TO RELATED APPLICATION

This application claims priority to Japanese Patent Application No. 2022-084713 filed on May 24, 2022, incorporated herein by reference in its entirety.

### BACKGROUND

### 1. Technical Field

The present disclosure relates to an information processing device, an information processing method, and a storage medium.

### 2. Description of Related Art

A technique is known in which a server estimates a road surface state based on information acquired by a vehicle (see, for example, Japanese Unexamined Patent Application Publication No. 2021-036454 (JP 2021-036454 A)).

### SUMMARY

An object of the present disclosure is to provide a technique in which a road can be efficiently maintained.

The present disclosure can be regarded as an information processing device that executes a first process of estimating a road surface state for each of a plurality of road sections based on a first value acquired by a vehicle traveling on each of the road sections. The information processing device in that case may include, for example, a control unit that executes the first process by excluding, from among the road sections, a first road section where first construction related to repair of a road surface has been performed.

The present disclosure can also be regarded as an information processing method in which a computer executes a first process of estimating a road surface state for each of a plurality of road sections based on a first value acquired by a vehicle traveling on each of the road sections. In the information processing method in that case, for example, the computer may execute the first process by excluding, from among the road sections, a first road section where first construction related to repair of a road surface has been performed.

The present disclosure can also be regarded as a program for causing a computer to execute the information processing method described above, or a non-transitory storage medium that stores the program.

According to the present disclosure, a technique that can efficiently maintain a road can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a maintenance system according to an embodiment;

FIG. 2 is a diagram showing an example of a configuration of an in-vehicle device according to the embodiment;

FIG. 3 is a block diagram showing an example of a functional configuration of a management server according to the embodiment;

FIG. 4 is a diagram showing an example of information stored in a vehicle information database;

FIG. 5 is a diagram showing an example of information stored in a road information database;

FIG. 6 is a flowchart showing a processing routine executed by the management server when an exclusion period is set;

FIG. 7 is a flowchart showing a processing routine executed by the management server when an estimation process is performed; and

FIG. 8 is a flowchart showing a processing routine executed by the management server when the exclusion period is canceled.

### DETAILED DESCRIPTION OF EMBODIMENTS

An information processing device according to the present disclosure is a computer that executes a first process of estimating a road surface state based on a first value acquired by a vehicle traveling on each of a plurality of road sections.

Here, for a road section of which a road surface state requires repair, construction mainly aimed at repairing a road surface (first construction) is performed. The road section where the first construction has been performed can be considered that the road surface state is in a good state.

Therefore, in the information processing device according to the present disclosure, a control unit executes the first process by excluding a first road section where the first construction has been performed from among the road sections. Thereby, a calculation load of a computer that executes the first process can be reduced. As a result, it becomes possible to efficiently maintain a road.

Hereinafter, an embodiment of the present disclosure will be described with reference to the drawings. The configuration described in the present embodiment is an example, and the present disclosure is not limited to the configuration of the embodiment.

### Embodiment

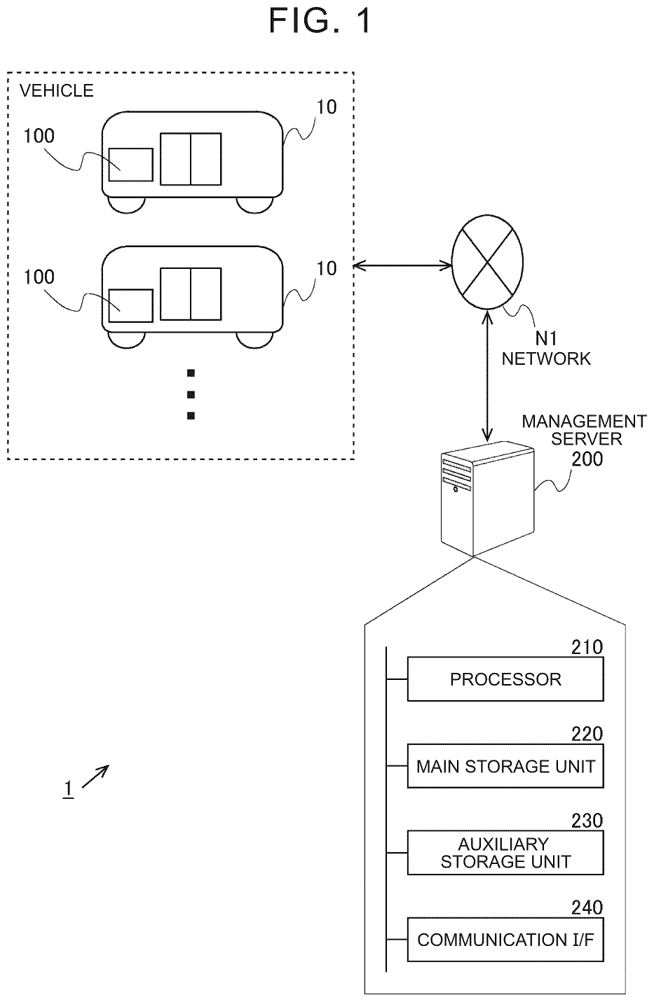

First, an embodiment of the present disclosure will be described based on FIGS. 1 to 7. In the present embodiment, an example in which the information processing device according to the present disclosure is applied to a maintenance system will be described. The maintenance system is a system for providing a road administrator, etc. with information necessary for maintaining the road.

### System Overview

FIG. 1 is a diagram showing a schematic configuration of a maintenance system 1 according to the present embodiment. The maintenance system 1 includes a plurality of vehicles 10 and a management server 200. In the maintenance system 1, the vehicles 10 and the management server 200 are interconnected by a network N1. The network N1 is a wide area network (WAN) that is a global public communication network such as the Internet, or any other communication networks.

### Vehicle

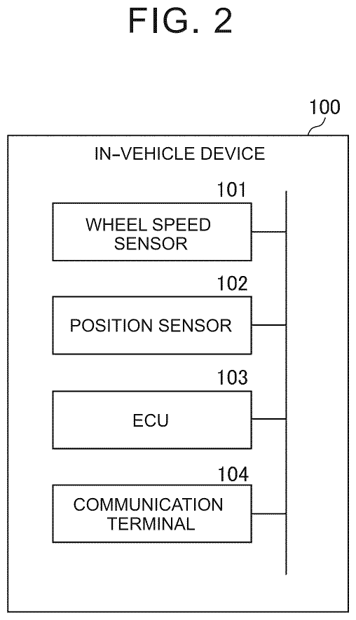

The vehicle 10 provides the management server 200 with information used for estimating the road surface state. The vehicle 10 in the present embodiment includes an in-vehicle device 100. The in-vehicle device 100 includes, for example, a wheel speed sensor 101, a position sensor 102, an electronic control unit (ECU) 103, a communication terminal 104, and the like, as shown in FIG. 2. The wheel speed sensor 101, the position sensor 102, the ECU 103, and the communication terminal 104 are interconnected by an in-vehicle network. The in-vehicle network is, for example, a network that conforms to a controller area network (CAN) standard, a local interconnect network (LIN) standard, or a FlexRay standard.

The wheel speed sensor 101 detects a speed of wheels of the vehicle 10. The position sensor 102 detects the position of the vehicle 10. The ECU 103 calculates a rate of change in a wheel speed per unit time (hereinafter also referred to as a “wheel speed change rate”) based on a detected value of the wheel speed sensor 101. The communication terminal 104 is connected to the network N1 by a mobile communication system or a wireless communication system, and communicates with the management server 200 through the network N1. The mobile communication system is, for example, long term evolution (LTE), LTE-Advanced, 5th Generation (5G), or 6th Generation (6G).

The communication terminal 104 in the present embodiment has a function of transmitting vehicle information to the management server 200. The vehicle information includes information for identifying the vehicle 10 (vehicle identification (ID)), the wheel speed change rate, the position of the vehicle 10 when the wheel speed used to calculate the wheel speed change rate is detected (detected value of the position sensor 102), and the date and time when the wheel speed used to calculate the wheel speed change rate is detected. The calculation of the wheel speed change rate and the transmission of the vehicle information are repeated at a predetermined cycle (for example, several tens of milliseconds to several seconds).

### Management Server

The management server 200 estimates and manages the road surface state for each road section. The management server 200 is, for example, a computer operated by a public organization that manages roads or a company entrusted by the public organization. The management server 200 corresponds to the “information processing device” according to the present disclosure. The management server 200 estimates the road surface state for each road section based on the vehicle information received from the vehicle 10 traveling on the road. A method for estimating the road surface state for each road section will be described below.

The management server 200 in the present embodiment includes a processor 210, a main storage unit 220, an auxiliary storage unit 230, a communication interface (communication I/F) 240, etc., as shown in FIG. 1. In FIG. 1, of the hardware components of the management server 200, only hardware components that perform a process related to the estimation of the road surface state are extracted and shown, and hardware components other than the hardware components shown in FIG. 1 can be included in the management server 200.

The processor 210 is, for example, a central processing unit (CPU) or a digital signal processor (DSP). The processor 210 controls the management server 200 by performing various arithmetic processes.

The main storage unit 220 includes, for example, semiconductor memories such as a random access memory (RAM) and a read-only memory (ROM). The main storage unit 220 provides a storage area and a work area for loading a program stored in the auxiliary storage unit 230. Further, the main storage unit 220 is used as a buffer for the arithmetic processes by the processor 210.

The auxiliary storage unit 230 is, for example, an erasable programmable ROM (EPROM), or a hard disk drive (HDD). The auxiliary storage unit 230 can include a removable medium, that is, a portable storage medium. The removable medium is, for example, a universal serial bus (USB) memory or a disc recording medium such as a compact disc (CD) or a digital versatile disc (DVD). The auxiliary storage unit 230 stores various programs and data used by the processor 210 when each program is executed. The programs stored in the auxiliary storage unit 230 include an operating system (OS) and a program for causing the processor 210 to execute the process related to the estimation of the road surface state.

The communication I/F 240 is an interface for connecting the management server 200 to the network N1. The communication I/F 240 is connected to the network N1 by, for example, the mobile communication system or the wireless communication system. In the present embodiment, the communication I/F 240 communicates with the vehicle 10 (communication terminal 104) through the network N1.

### Functional Configuration of Management Server

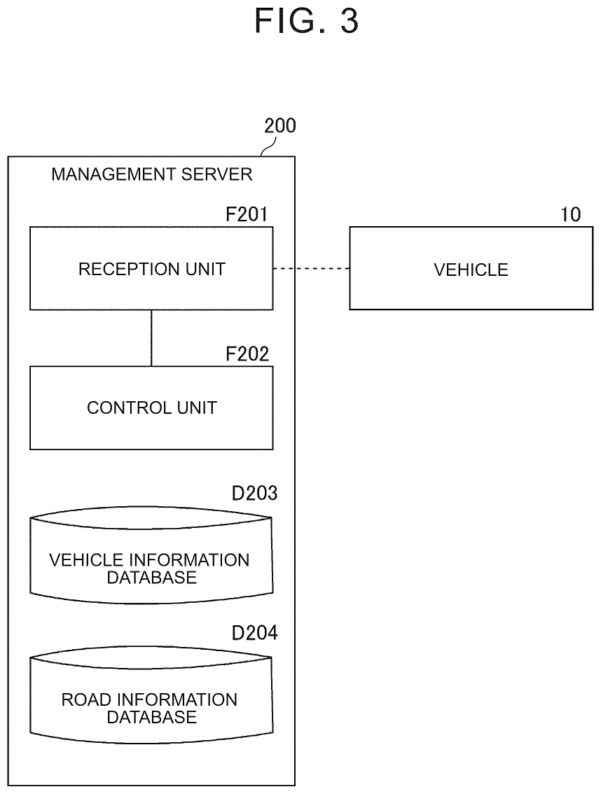

Here, the functional configuration of the management server 200 in the present embodiment will be described. FIG. 3 is a block diagram showing an example of a functional configuration of the management server 200 according to the present embodiment. The management server 200 in the present embodiment includes, as its functional components, a reception unit F201, a control unit F202, a vehicle information database D203, and a road information database D204.

The reception unit F201 and the control unit F202 are achieved by the processor 210 loading the program stored in the auxiliary storage unit 230 into the main storage unit 220 and executing the program. The processor 210 that achieves the reception unit F201 and the control unit F202 corresponds to the “control unit” of the information processing device according to the present disclosure.

The vehicle information database D203 and the road information database D204 are constructed by a program of a database management system (DBMS) executed by the processor 210 managing the data stored in the auxiliary storage unit 230. At that time, the vehicle information database D203 and the road information database D204 may be constructed as relational databases.

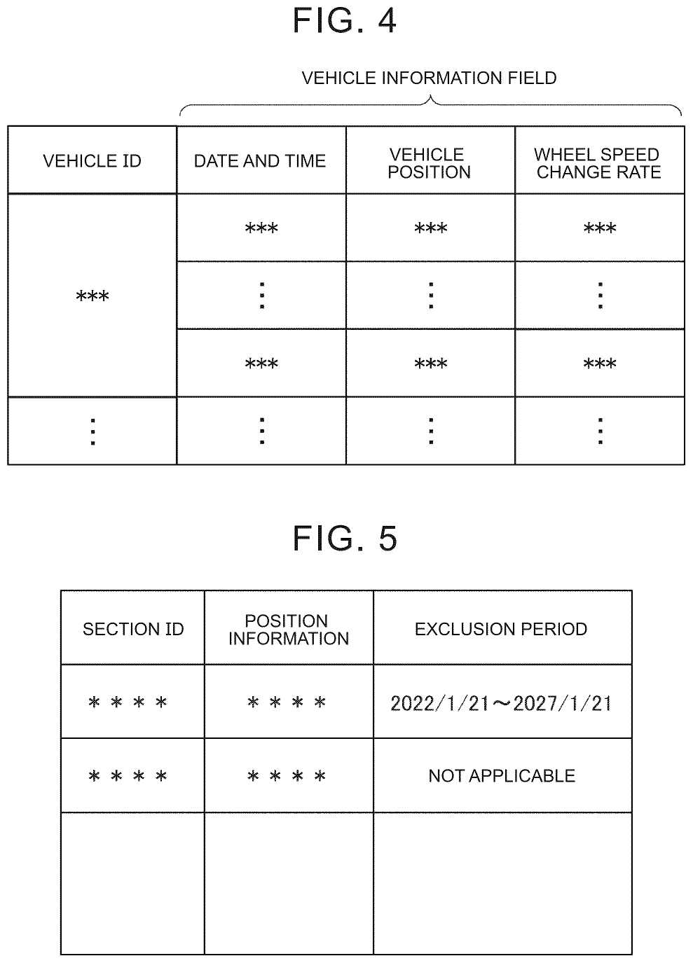

The vehicle information database D203 stores the vehicle information provided by the vehicles 10. FIG. 4 is a diagram showing an example of the information stored in the vehicle information database D203. A plurality of records each corresponding to each of the vehicles 10 is stored in the vehicle information database D203 shown in FIG. 4. Each record of the vehicle information database D203 includes a vehicle ID field and a vehicle information field. The vehicle information field includes each subfield of the date and time, the vehicle position, and the wheel speed change rate.

In the vehicle ID field, information for identifying each of the vehicles 10 (vehicle ID) is registered. In the date and time field of the vehicle information field, the date and time when the wheel speed sensor 101 detects the wheel speed used for calculating the wheel speed change rate in the vehicle 10 is registered. In the vehicle position field of the vehicle information field, the position of the vehicle 10 when the wheel speed sensor 101 detects the wheel speed used for calculating the wheel speed change rate in the vehicle 10 (detected value of the position sensor 102) is registered. The information registered in the vehicle position field is, for example, information indicating the latitude and longitude of the location where the wheel speed sensor 101 detects the wheel speed used for calculating the wheel speed change rate. In the wheel speed change rate field of the vehicle information field, the wheel speed change rate calculated in the vehicle 10 is registered.

In the present embodiment, a plurality of vehicle information fields can be associated with one vehicle ID field. This is because the vehicle information field is added each time the reception unit F201 receives the vehicle information from the corresponding vehicle 10. The addition of the vehicle information field is performed by the control unit F202 when the reception unit F201 receives the vehicle information from the corresponding vehicle 10.

Returning to FIG. 3, the description will be made. The road information database D204 stores information on roads under the management by the management server 200 for each road section. FIG. 5 is a diagram showing an example of the information stored in the road information database D204. A plurality of records each corresponding to each of the road sections is stored in the road information database D204 shown in FIG. 5. Each record of the road information database D204 includes a section ID field, a position information field, and an exclusion period field.

In the section ID field, information for identifying each the road sections (section ID) is registered. A road section may be defined by a plurality of road links or may be defined by one road link. Further, the one road link may be divided into a plurality of road sections, and a section ID may be assigned to each of the divided road sections. The division of the road sections is performed by, for example, the public organization or the like that manages roads under the management by the management server 200.

In the position information field, information indicating the position of each road section is registered. The information registered in the position information field is a collection of pieces of information indicating the position of each point in each road section. The position information of each point in each road section is, for example, information indicating the latitude and longitude of each point.

In the exclusion period field, information indicating a period during which each road section is excluded from a target of the estimation process described below is registered. The information registered in the exclusion period field includes, for example, information indicating the date on which the exclusion period starts and information indicating the date on which the exclusion period ends. In the exclusion period field for a road section for which the exclusion period is not set, information indicating that the exclusion period is not set (for example, information indicating “not applicable”) is registered. A method for setting the exclusion period will be described below.

Returning to FIG. 3, the description will be made. The reception unit F201 receives the vehicle information transmitted from the vehicles 10 through the communication I/F240. The vehicle information received by the reception unit F201 is transmitted to the control unit F202.

The control unit F202 stores the vehicle information received by the reception unit F201 in the vehicle information database D203. Specifically, the control unit F202 accesses the vehicle information database D203 using the vehicle ID included in the vehicle information as an argument, and specifies the record of the corresponding vehicle 10. That is, the control unit F202 specifies the record in which information matching the vehicle ID included in the vehicle information is registered in the vehicle ID field. The control unit F202 adds the vehicle information field to the specified record. The control unit F202 registers the information included in the vehicle information in each subfield (the date and time field, the vehicle position field, and the wheel speed change rate field) of the added vehicle information field.

In addition, when information on construction aimed at repairing the road surface (first construction) (hereinafter also referred to as “first information”) is received, the control unit F202 sets the exclusion period for the corresponding road section (first road section). The first information includes the section ID of the first road section, the area of the road surface repaired by the first construction, the end date of the first construction, and the like. Such first information may be input by an operator of the management server 200. Alternatively, the first information may be provided from an external server that manages the first construction to the management server 200 via the network N1. In that case, when the communication OF 240 receives the first information transmitted from the external server, the reception unit F201 may transmit the first information to the control unit F202. The control unit F202 may use the reception of the first information from the reception unit F201 as a trigger to set the exclusion period for the first road section.

In the present embodiment, the start date of the exclusion period is set to the same date as the end date of the first construction. Further, the end date of the exclusion period is determined based on the area of the road surface repaired by the first construction. Specifically, the control unit F202 first determines the length of the exclusion period (first period length) based on the area of the road surface repaired by the first construction. In the present embodiment, as the area of the road surface repaired by the first construction is large, the first period length is determined to be long. This is because when a part of the road surface included in the first road section is partially repaired, the repaired portion and/or the road surface around the repaired portion tend to deteriorate easily as the area of the repaired portion is small. Therefore, the first period length is determined to be short as the area of the repaired portion is small using the period length when the area of the road surface repaired by the first construction extends over the first road section as an upper limit value. The upper limit value at that time may be, for example, the same period length as the service life of a pavement material used in the first construction, or may be the period length obtained by subtracting a predetermined margin from the service life. When the first period length is determined as described above, the control unit F202 sets the date obtained by adding the first period length to the start date of the exclusion period as the end date of the exclusion period.

When the start date and end date of the exclusion period are set by the above method, the control unit F202 accesses the road information database D204 using the section ID included in the first information as an argument, and specifies the record for the first road section. That is, the control unit F202 specifies the record in which information matching the section ID included in the first information is registered in the section ID field. The control unit F202 registers the exclusion period in the exclusion period field in the specified record.

Further, the control unit F202 performs a process of estimating the road surface state of each road section (estimation process) based on the information stored in the vehicle information database D203 and the road information database D204. Specifically, the control unit F202 first accesses the road information database D204 using the section ID of the road section that is the target of the estimation process as an argument, and specifies the record for the target road section. The control unit F202 acquires information registered in the position information field of the specified record.

The control unit F202 collates the information acquired from the road information database D204 with the information registered in the vehicle position field of the vehicle information database D203. By performing the collation described above, the control unit F202 specifies a record of the vehicle 10 having a history of traveling on the target road section from among the records stored in the vehicle information database D203. Based on the information registered in the date and time field of the specified record, the control unit F202 extracts the record of the vehicle 10 having a history of traveling on the target road section during the period that is the target of the estimation process (hereinafter also referred to as the “corresponding vehicle 10”). The control unit F202 acquires information registered in the vehicle information field of the extracted record.

Based on the acquired vehicle information, the control unit F202 acquires the wheel speed change rate at each point when the corresponding vehicle 10 travels on the target road section during the period that is the target of the estimation process. At this time, when there is a plurality of the corresponding vehicles 10, the control unit F202 may calculate the average value of the wheel speed change rates at respective points of the vehicles 10, and may set the calculated average value as the wheel speed change rate at each point. Alternatively, the control unit F202 may set the largest wheel speed change rate among the wheel speed change rates at respective points of the corresponding vehicles 10 as the wheel speed change rate at each point.

When the wheel speed change rates are acquired for all of the points included in the target road section, the control unit F202 derives the wheel speed change rate for the target road section. In the present embodiment, the control unit F202 derives the largest wheel speed change rate among the wheel speed change rates at the points included in the target road section as the wheel speed change rate of the target road section. The control unit F202 may derive the average value of the wheel speed change rates at the points included in the target road section as the wheel speed change rate of the target road section.

When the wheel speed change rate of the target road section during the target period is obtained by the method described above, the control unit F202 determines whether the wheel speed change rate is greater than a predetermined threshold value. When the wheel speed change rate of the target road section is equal to or less than the predetermined threshold value, the control unit F202 estimates that the road surface state of the target road section does not require repair. On the other hand, when the wheel speed change rate of the target road section is greater than the predetermined threshold value, the control unit F202 estimates that the road surface state of the target road section requires repair.

The estimation process performed by the method described above is an example of the “first process” according to the present disclosure, and does not limit the first process. That is, the estimation of the road surface state of the target road section may be performed by other known methods. For example, instead of the wheel speed change rate, the vertical acceleration of the vehicle 10 or the like may be used to estimate the road surface state of the target road section. Further, instead of the wheel speed change rate, a road image captured by a camera mounted on the vehicle 10 may be used to estimate the road surface state of the target road section.

By the way, when the estimation process described above is performed for all of the road sections under the management by the management server 200, the calculation load of the management server 200 may be excessive. In contrast, in the present embodiment, the exclusion period is set in the exclusion period field of the road information database D204, and the first road section of which the target period is included in the exclusion period is excluded from the target of the estimation process. This is because it is assumed that the road surface state will not deteriorate to the point where repair is required during the exclusion period in the first road section where the first construction aimed at repairing the road surface has been performed. As a result, it is possible to reduce the number of road sections that is the target of the estimation process, so that the calculation load of the management server 200 can be reduced.

Either or a part of the reception unit F201 or the control unit F202 may be realized by a hardware circuit such as application specific integrated circuit (ASIC) or field programmable gate array (FPGA). Further, the functional components of the management server 200 are not limited to the example shown in FIG. 3, and the components may be omitted, replaced, or added as appropriate.

### Process Flow

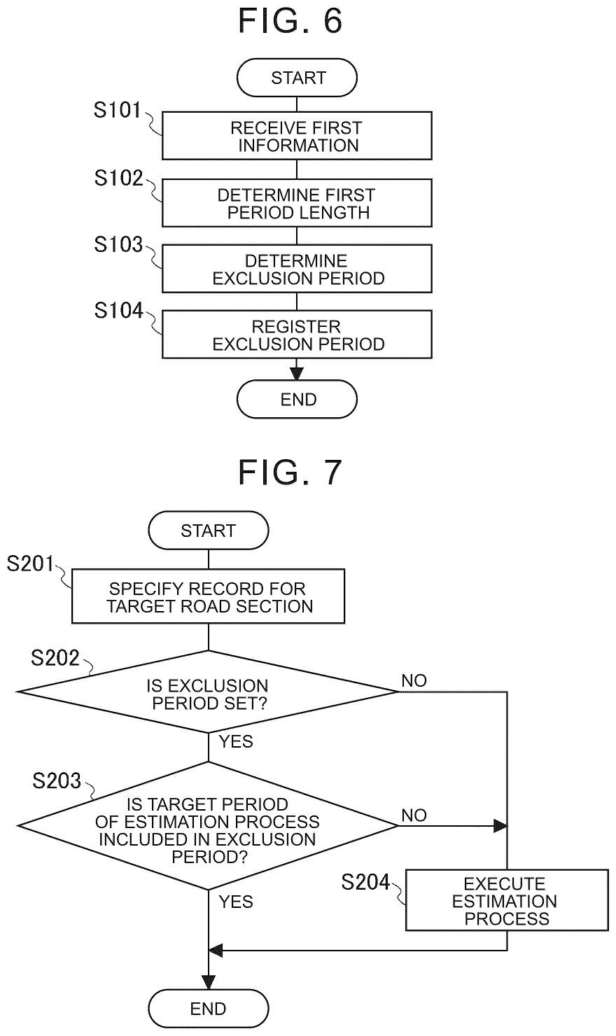

Here, a process flow performed by the management server 200 in the present embodiment will be described based on FIGS. 6 and 7. FIG. 6 shows a processing routine executed by the management server 200 when the exclusion period is set. The processing routine of FIG. 6 is executed with the reception of the first information as a trigger. FIG. 7 shows a processing routine executed by the management server 200 when the estimation process is performed. The processing routine of FIG. 7 is repeatedly executed at a predetermined cycle. The main body of execution of the processing routine in FIGS. 6 and 7 is the processor 210 of the management server 200. However, here, the functional components of the management server 200 will be described as the main body.

In FIG. 6, when the operator inputs the first information to the management server 200, the input first information is transmitted to the control unit F202 (S101). The first information is information on the first construction aimed at repairing the road surface. As described above, the first information includes the section ID of the road section where the first construction has been performed (first road section), the area of the road surface repaired by the first construction, the end date of the first construction, and the like. The first information may be provided from the external server that manages the first construction to the management server 200 via the network N1, as described above. In that case, when the communication OF 240 receives the first information transmitted from the external server, the reception unit F201 may transmit the first information to the control unit F202. After executing the process of step S101, the control unit F202 executes the process of step S102.

In step S102, the control unit F202 determines the first period length based on the first information. The first period length is a period length of the exclusion period. The control unit F202 determines the first period length based on the area of the road surface repaired by the first construction, which is included in the first information. In the present embodiment, the control unit F202 determines that the first period length is long as the area of the road surface repaired by the first construction is large. After executing the process of step S102, the control unit F202 executes the process of step S103.

In step S103, the control unit F202 determines the exclusion period based on the first information and the first period length. Specifically, the control unit F202 determines the same date as the end date of the first construction as the start date of the exclusion period. In addition, the control unit F202 determines the date obtained by adding the first period length to the start date of the exclusion period as the end date of the exclusion period. After executing the process of step S103, the control unit F202 executes the process of step S104.

In step S104, the control unit F202 registers the exclusion period determined in step S103 (start date and end date of the exclusion period) in the road information database D204. Specifically, the control unit F202 specifies the record for the first road section by accessing the road information database D204 using the section ID included in the first information as an argument. The control unit F202 registers the start date and end date of the exclusion period determined in step S103 in the exclusion period field in the record for the first road section. When the control unit F202 finishes executing the process of step S104, the execution of this processing routine ends.

Next, in FIG. 7, the control unit F202 accesses the road information database D204 to specify the record for the road section that is the target of the estimation process (step S201). That is, the control unit F202 specifies the record in which information matching the section ID of the target road section is registered in the section ID field from among the records stored in the road information database D204. After executing the process of step S201, the control unit F202 executes the process of step S202.

In step S202, the control unit F202 refers to the information registered in the exclusion period field in the record specified in step S201, and determines whether the exclusion period is set for the target road section. When the information indicating the start date and end date of the exclusion period is registered in the exclusion period field, the control unit F202 determines that the exclusion period is set for the target road section (affirmative determination in step S202). In this case, the target road section corresponds to the first road section. Further, when the information indicating “not applicable” is registered in the exclusion period field, the control unit F202 determines that the exclusion period is not set for the target road section (negative determination in step S202). In this case, the target road section does not correspond to the first road section.

When an affirmative determination is made in step S202, the control unit F202 executes the process of step S203. In step S203, the control unit F202 determines whether the target period of the estimation process is included in the exclusion period based on the information registered in the exclusion period field in the record specified in step S201. When the target period of the estimation process is included in the exclusion period (affirmative determination in step S203), the control unit F202 ends the execution of the processing routine without executing the estimation process for the target road section. As a result, the road section for which the exclusion period including the target period is set is excluded from the target of the estimation process.

Further, when a negative determination is made in step S202, and when it is determined in step S203 that the target period of the estimation process is not included in the exclusion period (negative determination in step S203), the control unit F202 executes the process of step S204. In step S204, the control unit F202 executes the estimation process for estimating the road surface state of the target road section. After completing the process of step S204, the control unit F202 ends the execution of the processing routine.

According to the above-described embodiment, among the road sections under the management by the management server 200, the first road section where the first construction aimed at repairing the road surface has been performed is excluded from the target of the estimation process until the exclusion period elapses from the end date of the first construction. Thereby, the calculation load of the management server 200 can be reduced. In addition, since the period length of the exclusion period (first period length) is set to be short as the area of the road surface where the first construction has been performed becomes small, it is possible to resume the estimation process for the first road section before the road surface state deteriorates to a state in which repair is required.

### First Modification

In the above-described embodiment, the example is shown in which the first road section where the first construction has been performed among the road sections under the management by the management server 200 is excluded from the target of the estimation process until the exclusion period elapses. On the other hand, in this modification, the example is shown in which when construction mainly aimed at repair other than the repair of the road surface (second construction) is performed during the exclusion period of the first road section, the estimation process for the first road section is resumed without waiting for the end of the exclusion period.

The second construction here is, for example, construction aimed at maintaining lifeline facilities (for example, water pipes, gas pipes, power transmission pipes, etc.) buried under the road in the first road section. After the completion of the second construction described above, the road surface is repaved. However, a step may be generated between a road surface on the repaved portion and a road surface on the other portions, or pavement materials used for the repaved portion may be different from those of the other portions. In such a case, there is a possibility that the wheel speed change rate of the vehicle 10 traveling on the above-described step becomes excessive, or the boundary between the repaved portion and the other portions is likely to deteriorate.

Therefore, in this modification, when the second construction is performed in the first road section before the exclusion period for the first road section elapses, the estimation process for the first road section is resumed.

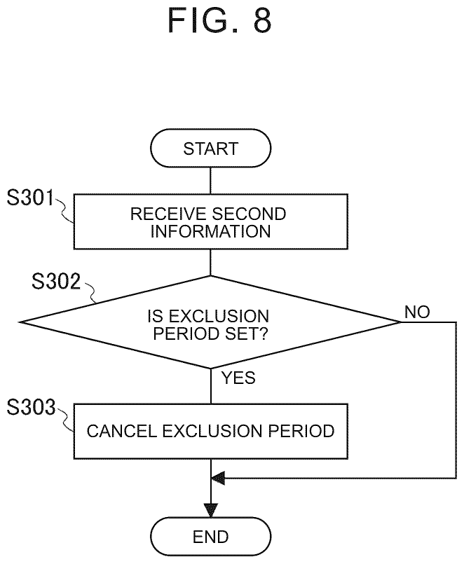

FIG. 8 is a flowchart showing s a processing routine executed by the management server 200 using the input of the information on the second construction (hereinafter also referred to as the “second information”) to the management server 200 by the operator as a trigger. The second information includes the section ID for the road section where the second construction has been performed. The second information may be provided from an external server that manages the second construction to the management server 200 via the network N1. In that case, when the communication I/F 240 receives the second information transmitted from the external server, the reception unit F201 may transmit the second information to the control unit F202. The control unit F202 may use the reception of the second information from the reception unit F201 as a trigger to execute the processing routine of FIG. 8.

In FIG. 8, when the operator inputs the second information to the management server 200, the input second information is transmitted to the control unit F202 (S301). After executing the process of step S301, the control unit F202 executes the process of step S302.

In step S302, the control unit F202 determines whether the exclusion period is set for the road section where the second construction has been performed. Specifically, the control unit F202 accesses the road information database D204 using the section ID included in the second information as an argument, and specifies the record for the road section where the second construction has been performed. The control unit F202 determines whether the exclusion period is registered in the exclusion period field in the specified record. When the exclusion period is registered in the exclusion period field (affirmative determination in step S302), the control unit F202 executes the process of step S303.

In step S303, the control unit F202 cancels the exclusion period for the road section where the second construction has been performed. Specifically, the control unit F202 deletes the exclusion period registered in the exclusion period field in the record for the road section where the second construction has been performed, and registers information indicating “not applicable”. After completing the process of step S303, the control unit F202 ends the execution of the processing routine. As a result, the estimation process for the road section where the second construction has been performed is resumed.

In step S302, when the exclusion period is not registered in the exclusion period field, that is, when the information indicating “not applicable” is registered in the exclusion period field (negative determination in step S302), the control unit F202 skips the process of S303 and ends the execution of the processing routine.

According to this modification, even when the second construction is performed during the exclusion period for the first road section, it is possible to appropriately manage the road surface state of the first road section.

Even when a disaster or the like occurs during the exclusion period for the first road section, the control unit F202 may cancel the exclusion period for the first road section in the same manner as when the second construction is performed. Further, even when an excessive wheel speed change rate is detected in the vehicle 10 traveling on the first road section before the exclusion period for the first road section elapses, the control unit F202 may cancel the exclusion period for the first road section.

### Second Modification

In the above-described embodiment, the example is shown in which the first road section is unconditionally excluded from the target of the estimation process until the exclusion period elapses. On the other hand, the first road section may be excluded from the target of the estimation process under the condition that an estimation result obtained by performing the estimation process for the first road section when the first construction ends satisfies a predetermined criterion (for example, the wheel speed change rate for the first road section is smaller than a reference value (reference value<predetermined threshold value)). As a result, even when there is a defect in the first construction, the road surface state of the first road section can be appropriately managed.

### Third Modification

In the above-described embodiment, the example is shown in which the first road section is excluded from the target of the estimation process until the exclusion period elapses regardless of the content of the first construction. On the other hand, when the content of the first construction is partial repair such as pothole repair, the first road section may not be excluded from the target of the estimation process. This is because even when a road surface with the pothole or the like is partially repaired, the repaired portion or the area around the repaired portion may easily deteriorate. Thereby, the road surface state of the first road section can be preferably managed.

### Fourth Modification

In the above-described embodiment, the example is shown in which the period length of the exclusion period (first period length) is determined according to the area of the road surface repaired by the first construction. On the other hand, the first period length may be determined based on the estimated value of the traffic volume in the first road section or the durability of the pavement material used in the first construction. For example, the control unit F202 may determine that the first period length is longer when the estimated value of the traffic volume of the first road section (first estimated value) is small than when the first estimated value is large. The first estimated value may be determined based on a statistical value of past traffic volume or the like. In addition, the control unit F202 may set the exclusion period longer when the durability of the pavement material used in the first construction is high than when the durability thereof is low.

The control unit F202 may determine the first period length based on at least two of the area of the road surface repaired by the first construction, the estimated value of the traffic volume of the first road section, and the durability of the pavement material used in the first construction.

### Others

The above-described embodiment and modifications are merely examples, and the present disclosure may be appropriately modified to be implemented without departing from the scope thereof. Also, the processes and the configurations described in the present disclosure can be appropriately combined to be implemented as long as no technical contradiction occurs.

Further, the processes described as being executed by one device may be shared and executed by a plurality of devices. The processes described as being executed by different devices may be executed by one device. In the computer system, it is possible to flexibly change the hardware configuration for implementing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read only memory (EEPROM), a magnetic card, a flash memory, or any type of medium suitable for storing electronic commands such as an optical card.

What is claimed is:

1. An information processing device that executes a first process of estimating a road surface state for each of a plurality of road sections based on a first value acquired by a vehicle traveling on each of the road sections, the information processing device comprising a control unit that executes the first process by excluding, from among the road sections, a first road section where first construction related to repair of a road surface has been performed.

2. The information processing device according to claim 1, wherein the control unit resumes the first process for the first road section when a first period length elapses after the first construction is ended.

3. The information processing device according to claim 2, wherein the control unit sets the first period length according to an area of the road surface repaired by the first construction.

4. The information processing device according to claim 3, wherein the control unit sets the first period length longer when the area of the road surface repaired by the first construction is large than when the area of the road surface repaired by the first construction is small.

5. The information processing device according to claim 2, wherein the control unit sets the first period length according to a first estimated value that is an estimated value of traffic volume in the first road section.

6. The information processing device according to claim 5, wherein the control unit sets the first period length longer when the first estimated value is small than when the first estimated value is large.

7. The information processing device according to claim 2, wherein the control unit sets the first period length according to durability of a pavement material used in the first construction.

8. The information processing device according to claim 7, wherein the control unit sets the first period length longer when the durability of the pavement material used in the first construction is high than when the durability of the pavement material used in the first construction is low.

9. The information processing device according to claim 2, wherein the control unit executes:
the first process targeting the first road section when the first construction is ended; and
the first process by excluding the first road section until the first period length elapses after the first construction is ended when the road surface state estimated by the first process satisfies a predetermined criterion.

10. The information processing device according to claim 2, wherein the control unit resumes the first process for the first road section when second construction aimed at repair other than the repair of the road surface is performed for at least a part of the road surface of the first road section before the first period length elapses.

11. The information processing device according to claim 10, wherein the second construction is construction aimed at repairing a lifeline facility buried under the road surface of the first road section.

12. The information processing device according to claim 1, wherein when the first construction is construction to repair a pothole in the first road section, the control unit executes the first process without excluding the first road section.

13. An information processing method, wherein a computer that executes a first process of estimating a road surface state for each of a plurality of road sections based on a first value acquired by a vehicle traveling on each of the road sections executes the first process by excluding, from among the road sections, a first road section where first construction related to repair of a road surface has been performed.

14. The information processing method according to claim 13, wherein the computer resumes the first process for the first road section when a first period length elapses after the first construction is ended.

15. The information processing method according to claim 14, wherein the computer sets the first period length according to an area of the road surface repaired by the first construction.

16. The information processing method according to claim 14, wherein the computer sets the first period length in response to a first estimated value that is an estimated value of traffic volume in the first road section.

17. The information processing method according to claim 14, wherein the computer executes:
the first process for the first road section when the first construction is ended; and
the first process by excluding the first road section until the first period length elapses after the first construction is ended when the road surface state estimated by the first process satisfies a predetermined criterion.

18. The information processing method according to claim 14, wherein the computer resumes the first process for the first road section when second construction aimed at repair other than the repair of the road surface is performed for at least a part of the road surface of the first road section before the first period length elapses.

19. The information processing method according to claim 13, wherein when the first construction is construction to repair a pothole in the first road section, the computer executes the first process without excluding the first road section.

20. A non-transitory storage medium storing a program for causing a computer that executes a first process of estimating a road surface state for each of a plurality of road sections based on a first value acquired by a vehicle traveling on each of the road sections to execute the first process by excluding, from among the road sections, a first road section where first construction related to repair of a road surface has been performed.
